(19) United States
(12) Patent Application Publication
(10) Pub. No.: US 2004/0051799 A1
(43) Pub. Date: Mar. 18, 2004

(54) Image processing method and image processing apparatus

(75) Inventor: Mutsuhiro Yamanaka, Suita-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/309,533

(22) Filed: Dec. 4, 2002

(30) Foreign Application Priority Data
Sep. 18, 2002 (JP) P2002-271419

(51) Int. Cl. H04N 5/335

(52) U.S. Cl. 348/272; 348/222.1

(57) ABSTRACT

The present invention is directed to provide a technique of interpolating a green signal efficiently with excellent reproducibility of a high frequency pattern while suppressing an interpolation error. A process of interpolating a green signal in an image signal outputted from a CCD image pickup device 13 having a Bayer pattern is performed. A G signal interpolating unit 21 extracts green light sensing pixels of total n pieces (where n denotes an integer of four or larger) which include two nearest neighbor green light sensing pixels in an oblique direction and exist in the same direction from a green image signal obtained from the CCD image pickup device 13. The (n−1)th order function for approximating the illumination distribution of a green image received by the n green light sensing pixels is set, and the signal value of a pixel to be interpolated which is positioned in the same direction as the n pixels is derived from the (n−1)th order function.

This application is based on application No. 2002-271419 filed in Japan, the contents of which are hereby incorporated by reference.

### BACKGROUND OF THE INVENTION

1. Field of the Invention

The present invention relates to an image processing technique for performing a process of interpolating a green signal in image signals outputted from an image pickup device having a Bayer pattern.

2. Description of the Background Art

In the case of capturing a color image by an image pickup device of a single chip having a Bayer pattern, green signals exist in a checker state in an image plane, and dropped-out green signals have to be interpolated.

Conventionally, according to one of interpolating methods of this kind, at the time of interpolating a dropped-out green signal, a correlation value of neighboring pixels distributed in the vertical direction of a pixel to be interpolated and a correlation value of neighboring pixels distributed in the horizontal direction are obtained. The direction of the higher correlation value is selected and an interpolating operation is performed while considering a plurality of green signals in the selected direction. This method is disclosed in Japanese Patent Application Laid-Open No. 2001-320720.

According to another interpolating method, by two-dimensionally applying cubic convolution interpolation to image signals obtained from the image pickup device, a dropped-out green signal can also be interpolated. This method is disclosed in Japanese Patent Application Laid-Open No. 2000-278503.

However, the conventional methods are techniques of estimating the signal value of a dropout pixel on the basis of pixel signals which are apart from each other by a pitch of one or more pixels in the vertical or horizontal direction. Consequently, they have a problem such that a high-frequency stripe pattern in which the maximum and the minimum are intervals each almost equal to a pixel pitch, and the like cannot be accurately reproduced.

Particularly, in the former interpolating method, there is a case where an abnormal signal value generates by an influence of noise or the like and the direction of higher correlation is erroneously determined. It causes a problem such that the image pickup device with a deteriorated S/N ratio due to a narrowed pixel cannot display sufficient effects.

In the latter interpolating method, in order to interpolate a dropout signal, peripheral signals have to be referred to two-dimensionally in a wide range to perform cubic convolution interpolating operation. Consequently, there is also a problem such that the circuit scale increases and the computation efficiency is low.

### SUMMARY OF THE INVENTION

The present invention is directed to an image processing method of performing a process of interpolating a green signal in an image signal outputted from an image pickup device having a Bayer pattern.

According to a first aspect of the present invention, the method includes the following steps of: extracting total n pieces (where n is an integer of four or larger) of green light sensing pixels which include two nearest neighbor green light sensing pixels in an oblique direction and exist in the same direction as the two green light sensing pixels from the image signal; obtaining an illumination distribution of a green image received by the n green light sensing pixels; and deriving a signal value of an interpolation green pixel positioned in the oblique direction from the illumination distribution.

Therefore, the efficient interpolating operation with excellent reproducibility of a high frequency pattern with little interpolation error can be realized.

According to a second aspect of the present invention, in the method, the interpolation green pixel is in a midpoint position between the two green light sensing pixels.

Consequently, the signal value of a green pixel to be interpolated can be obtained with high precision.

According to a third aspect of the present invention, in the method, the illumination distribution is set as an (n−1)th order function so that a value obtained by integrating the illumination distribution at a pixel aperture with respect to each of the n green light sensing pixels becomes a signal value of each green light sensing pixel.

Therefore, the illumination distribution adapted to actual photoelectric conversion in the image pickup device can be set, and the interpolating operation can be performed with high precision.

According to a fourth aspect of the present invention, in the method, the pixel aperture is a region virtually enlarged by an optical low-pass filter.

Consequently, the distribution of illumination sensed by each of pixels of the image pickup device can be accurately reproduced and the interpolating operation can be performed with high precision.

The present invention is also directed to an image processing method of performing a process of interpolating a specific color element on an image signal outputted from an image pickup device in a state where a plurality of color elements constructing an image are distributed in a predetermined pattern.

According to the present invention, the method includes the steps of: extracting a plurality of pixels of the specific color element existing in an oblique direction from the image signal; obtaining an illumination distribution of an image received by the plurality of pixels; and obtaining a signal value of a pixel to be interpolated from the illumination distribution.

The present invention is also directed to an image processing apparatus for performing a process of interpolating a green signal in an image signal outputted from an image pickup device having a Bayer pattern.

According to the present invention, the apparatus includes: a pixel extracting unit for extracting total n pieces (where n is an integer of four or larger) of green light sensing pixels which include two nearest neighbor green light sensing pixels in an oblique direction and exist in the same direction as the two green light sensing pixels from the image signal; an illumination distribution setting unit for obtaining an illumination distribution of a green image received by the n green light sensing pixels; and a computing unit for deriving a signal value of an interpolation green pixel positioned in the oblique direction from the illumination distribution.

As described above, the present invention has been achieved to solve the problems of the conventional techniques and its object is to provide a technique of interpolating a green signal efficiently with excellent reproducibility of a high frequency pattern and with little interpolation error.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a main internal structure of an image capturing apparatus;

FIG. 2 is a diagram showing pixel arrangement in a photosensitive surface of a CCD image pickup device of a Bayer pattern type;

FIG. 3 is a diagram showing an example of a decomposed state of an image by an optical low-pass filter;

FIG. 4 is a partially enlarged view the pixel arrangement of the CCD image pickup device;

FIG. 5 is a schematic diagram showing the effect of the optical low-pass filter;

FIG. 6 is a diagram showing the concept of a pixel aperture virtually enlarged by the action of the optical low-pass filter;

FIG. 7 is a diagram showing an example of the detailed configuration of a G signal interpolating unit;

FIG. 8 is a diagram showing a case where an illumination distribution is assumed in an oblique direction;

FIG. 9 is a diagram showing a pixel aperture of four pixels whose pixel apertures are overlapped;

FIG. 10 is a diagram showing another example of the detailed configuration of the G signal interpolating unit;

FIG. 11 is a diagram showing the position of an interpolation pixel (pixel to be interpolated);

FIG. 12 is a diagram showing the positional relation between the interpolation pixel (pixel to be interpolated) and a red photosensitive pixel;

FIG. 13 is a diagram expressing the relation of FIG. 12 as a pixel aperture;

FIG. 14 is a flowchart showing the procedure of an interpolating process in the image pickup device;

FIG. 15 is a diagram showing the schematic configuration of an image processing system;

FIG. 16 is a diagram showing functions realized in the image processing apparatus; and

FIG. 17 is a diagram showing a case where the aperture ratio of pixels is lower than 100%.

### DESCRIPTION OF THE PREFERRED EMBODIMENTS

Hereinafter, embodiments of the present invention will be described in detail with reference to the drawings.

1. First Embodiment

A first embodiment will be described. The first embodiment relates to a case of performing a process of interpolating a green signal in an image capturing apparatus such as a digital camera.

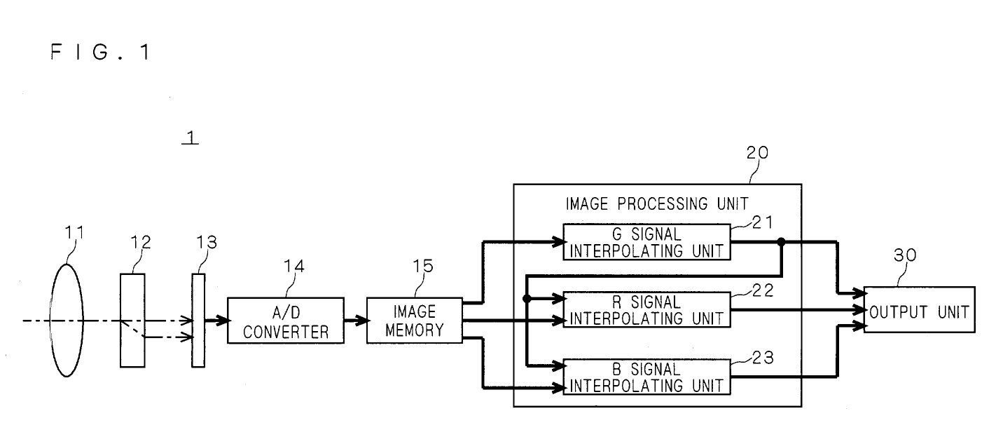

FIG. 1 is a diagram showing a main internal structure of an image capturing apparatus 1 such as a digital camera. The image capturing apparatus 1 includes an imaging lens 11, an optical low-pass filter 12, a CCD image pickup device 13, an A/D converter 14, an image memory 15, an image processing unit 20, and an output unit 30. Light entering via the imaging lens 11 is led through the optical low-pass filter 12 to the CCD image pickup device 13. The CCD image pickup device 13 is constructed in such a manner that a plurality of pixels are arranged two-dimensionally on the photosensitive surface and each of the pixels in a so-called single-chip Bayer pattern receives light of any of color components of R (red), G (green) and B (blue).

FIG. 2 is a diagram showing a pixel arrangement on the photosensitive surface of the CCD image pickup device 13 of the Bayer pattern type. As shown in FIG. 2, in the first line (the uppermost line) in the horizontal direction H, a pixel for detecting the B component and a pixel for detecting the G component are alternately arranged. In the second line, a pixel for detecting the G component and a pixel for detecting the R component are alternately arranged. A plurality of lines each having a similar pixel arrangement are arranged in the vertical direction V. By photoelectric conversion performed in each pixel, the CCD image pickup device 13 can output a color image.

On the surface of each of the pixels of the CCD image pickup device 13, a not-shown microlens is disposed. By the effect of the microlens, all of the light components incident on the CCD image pickup device 13 are appropriately led to the pixels. Consequently, the CCD image pickup device 13 is constructed so that the aperture ratio of the pixels becomes almost 100% theoretically.

Pixel signals obtained by photoelectric conversion performed in the CCD image pickup device 13 are outputted to the A/D converter 14. The A/D converter 14 converts each of the pixel signals to a digital signal, thereby generating so-called raw image data. The raw image data is outputted to the image memory 15 and temporarily stored therein.

The raw image data is formed from an image obtained by the photoelectric conversion in the CCD image pickup device 13. Each of the pixel signals indicates the signal value of a color component corresponding to a color pattern (that is, Bayer pattern) of the CCD image pickup device 13. Therefore, the green signals (G signals) detecting the G component exist in a checker pattern in the image plane.

The image processing unit 20 includes a G signal interpolating unit 21, an R signal interpolating unit 22 and a B signal interpolating unit 23. The G signal interpolating unit 21 extracts the G signals distributed in a checker pattern from the image memory 15, performs a process of interpolating dropout pixels, and output a G signal interpolated image. The details of the G signal interpolating unit 21 will be described later.

The R signal interpolating unit 22 extracts red signals (R signals) from the image memory 15, receives the G signal interpolated image from the G signal interpolating unit 21 and, on the basis of the R signals and the G signal interpolated image, generates and outputs an R signal interpolated image. Similarly, the B signal interpolating unit 23 extracts blue signals (B signals) from the image memory 15, receives the G signal interpolated image from the G signal interpolating unit 21 and, on the basis of the B signals and the G signal interpolated image, generates and outputs a B signal interpolated image.

As a result, in the image processing unit 20, the interpolating process is performed for each color component on the image corresponding to the Bayer pattern of the CCD image pickup device 13, and an image of each color component is outputted to the output unit 30.

The output unit 30 has the function of outputting image data to a data processing unit for performing secondary data processes on the interpolated image data, a recording medium and the like.

In the image capturing apparatus 1 having such a configuration, the optical low-pass filter 12 is provided to prevent generation of a pseudo color (aliasing distortion) in the single-chip CCD image pickup device 13 having the single-chip Bayer pattern. Light entering the imaging lens 11 is double refracted to the horizontal direction H and the vertical direction V by the optical low-pass filter 12 and is incident on the CCD image pickup device 13.

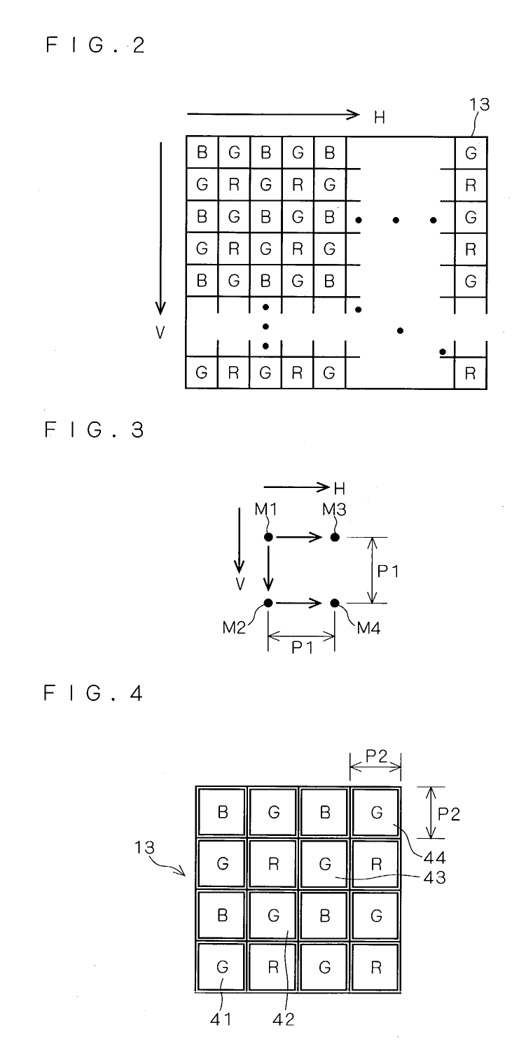

FIG. 3 is a diagram showing an example of a state where an image is decomposed by the optical low-pass filter 12 and shows a plane perpendicular to the optical axis. As shown in FIG. 3, an original image MI of light incident on the imaging lens 11 is decomposed into the horizontal and vertical directions H and V by the effect of the optical low-pass filter 12, thereby forming decomposed images M2, M3 and M4. Each of the decomposed images M2, M3 and M4 are formed apart from the original image M1 by a decomposition width P1 in both of the horizontal and vertical directions H and V. By generating the decomposed images M2, M3 and M4, in each of the R and B signals of which a sampling frequency in each of the horizontal and vertical directions H and V is the half of that of the G signal, an aliasing component can be suppressed. In order to reduce aliasing distortion by the effect of the optical low-pass filter 12, it is the most effective to set the frequency characteristic of the optical low-pass filter 12 so that the response of an optical image becomes zero at the half of the sampling frequency of the G signal. Consequently, the optical low-pass filter 12 is disposed so that the decomposition width P1 becomes equal to the pixel pitch of the CCD image pickup device 13.

FIG. 4 is a partially enlarged diagram of the pixel arrangement of the CCD image pickup device 13. The pixels are arranged at a pixel pitch P2 in each of the horizontal and vertical directions H and V, and the decomposition width P1 of an image by the optical low-pass filter 12 is set to be equal to the pixel pitch P2 shown in FIG. 4.

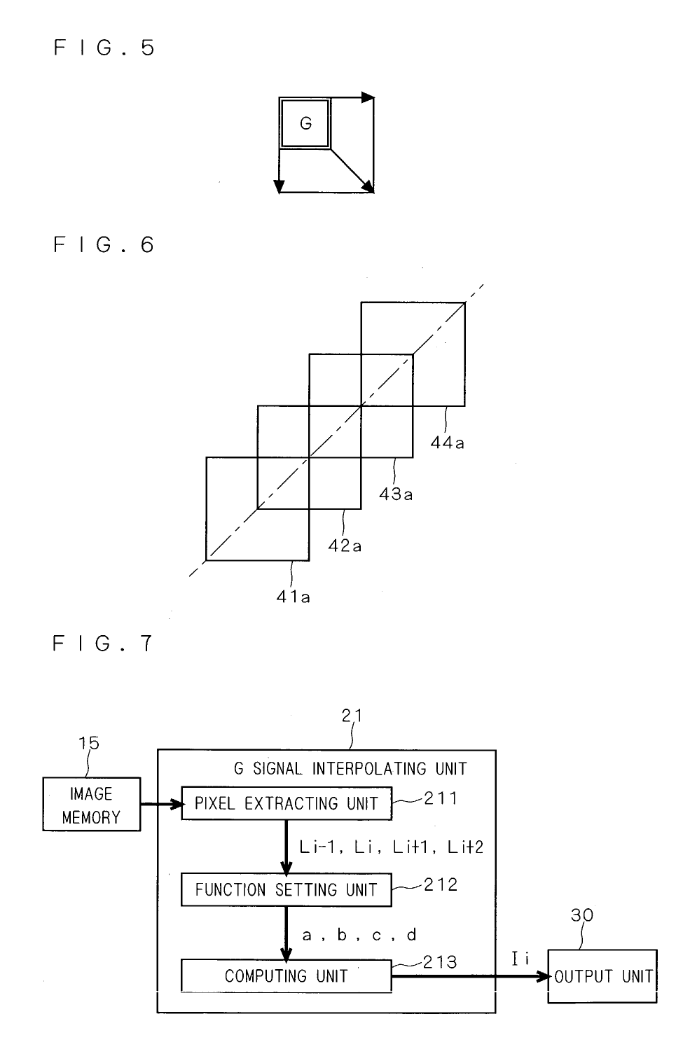

Double images (two-dimensionally quadruple images) are formed on the CCD image pickup device 13 by the effect of the optical low-pass filter 12. As a result, an output signal from each pixel is theoretically equivalent to an output signal sampled with the enlarged aperture of each pixel as shown in FIG. 5. Therefore, when it is assumed that the aperture ratio of each pixel in the CCD image pickup device 13 is 100% and the decomposition width P1 in the optical low-pass filter 12 and the pixel pitch P2 of the CCD image pickup device 13 are equal to each other, the pixel aperture of four green light sensing pixels 41, 42, 43 and 44 which are neighboring in an oblique direction in FIG. 4 is virtually enlarged to twice, that is, 200%.

FIG. 6 is a diagram showing the concept of a pixel aperture virtually enlarged by the effect of the optical low-pass filter 12 and illustrates pixel apertures 41a, 42a, 43a and 44a enlarged twice as large as those of the four green light sensing pixels 41, 42, 43 and 44 in FIG. 4. As shown in FIG. 6, when the pixel apertures of the green light sensing pixels 41, 42, 43 and 44 are enlarged by twice, the pixel apertures which are neighboring each other in the oblique direction are overlapped with each other by the quarter of the aperture area of each pixel aperture. In other words, the quarter of the pixel aperture of one of two nearest neighbor green light sensing pixels in the oblique direction is overlapped with the quarter of the pixel aperture of the other pixel.

Therefore, from the CCD image pickup device 13 of the above configuration, a G signal detected through the pixel apertures overlapped with each other in the oblique direction is outputted. In the embodiment, in consideration of the property of the G signal detected in a state where the pixel apertures are overlapped with each other, the G signal interpolating process is performed.

FIG. 7 is a diagram showing an example of the detailed configuration of the G signal interpolating unit 21. The G signal interpolating unit 21 includes a pixel extracting unit 211, a function setting unit 212 and a computing unit 213. For example, the G signal interpolating unit 21 extracts the four green light sensing pixels 41, 42, 43 and 44 positioned on a straight line including two nearest neighbor pixels 42 and 43 in the oblique direction and, on the basis of the G signals, calculates a green signal value of an interpolation green pixel positioned in the center of the four green light sensing pixels 41, 42, 43 and 44.

The pixel extracting unit 211 extracts, for example, the two nearest neighbor pixels 42 and 43 in the oblique direction as shown in FIG. 4 from a green image signal constructed by the green light sensing pixels and, further, extracts the green light sensing pixels 41 and 44 which are lined on the straight line with the pixels 42 and 43.

The function setting unit 212 determines a function approximating a distribution of illumination of light received by each of the pixels 41 to 44. The details of the process will be described later.

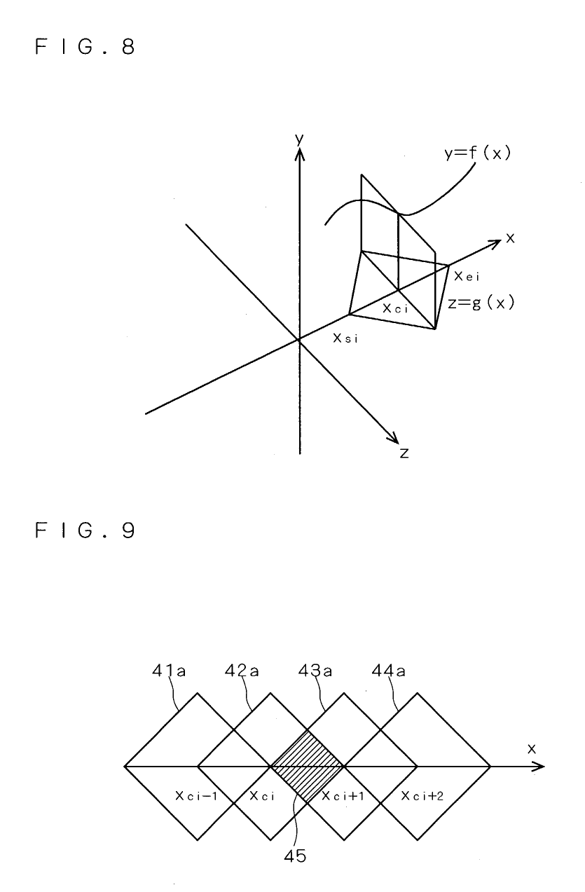

FIG. 8 is a diagram showing a case where a one-dimensional illumination distribution in the direction in which the four pixels 41 to 44 are lined. The X-direction indicates the direction (that is, oblique direction) in which the four pixels are lined in the CCD image pickup device 13, the Z-direction indicates a direction perpendicular to the X-direction in the photosensitive surface of the CCD image pickup device 13, and the Y-direction indicates an illumination component.

When an illumination distribution function f(X) is defined by a cubic function, it is expressed as follows:

f(X)=aX³+bX³+cX+d Equation 1

where, a, b, c and d indicate coefficients specifying an illumination distribution. When the center position of the aperture of each of the four pixels is set as X=Xci and the positions on both ends of the aperture are set as Xsi and Xei, a function g(X) defining the pixel aperture is expressed as follows:

g(X)=X−Xsi(where X<Xci), g(X)=−X+Xei(where X>Xci) Equation 2

Since an output signal Li from a pixel in the center position Xci of the pixel aperture is proportional to an average illumination in the pixel aperture, the output signal Li is obtained by integrating the product between the illumination distribution and the aperture width along the X-axis direction and dividing the integrated value by the aperture area. That is, the G signal Li is obtained by the following expression:

$$Li = 4 k {\int }_{Xsi}^{Xei} g ( X ) f ( X ) ⅆ X / {( Xei - Xsi )}^{2} \qquad Equation 3$$

where, in Equation 3, k denotes a proportional constant used to convert illumination to a signal value and is a value determined according to the characteristic of the CCD image pickup device 13.

When Equations 1 and 2 are substituted for Equation 3 to further simplify each of coefficients specifying the illumination distribution, Equation 3 is expressed as follows:

$$\begin{matrix}\frac{{( Xei - Xsi )}^{2}}{4 k} Li = a ( \frac{4}{10} {Xci}^{5} - \frac{1}{4} {Xci}^{4} Xsi - \frac{1}{4} {Xci}^{4} Xei + \frac{3}{20} {Xsi}^{5} + \frac{3}{20} {Xei}^{5} ) \\ + b ( \frac{1}{2} {Xci}^{4} - \frac{2}{6} {Xci}^{3} Xsi - \frac{2}{6} {Xci}^{3} Xei + \frac{1}{12} {Xsi}^{4} + \frac{1}{12} {Xei}^{4} ) \\ + c ( \frac{4}{6} {Xci}^{3} - \frac{1}{2} {Xci}^{2} Xsi - \frac{1}{2} {Xci}^{2} Xei + \frac{1}{6} {Xsi}^{3} + \frac{1}{6} {Xei}^{3} ) \\ + d ( {Xci}^{2} - XciXsi - XciXei + \frac{1}{2} {Xsi}^{2} + \frac{1}{2} {Xei}^{2} )\end{matrix} \qquad Equation 4$$

where, in Equation 4, k is known from the characteristics of the CCD image pickup device 13 and each of Xei, Xci and Xsi can be preliminarily obtained from the relation between the characteristic of the optical low-pass filter 12 and the pixel arrangement of the CCD image pickup device 13. Further, the G signal Li is determined by the output signal from the pixel in the center position Xci of the pixel aperture. Therefore, unknown values in Equation 4 are coefficients a, b, c and d specifying the illumination distribution.

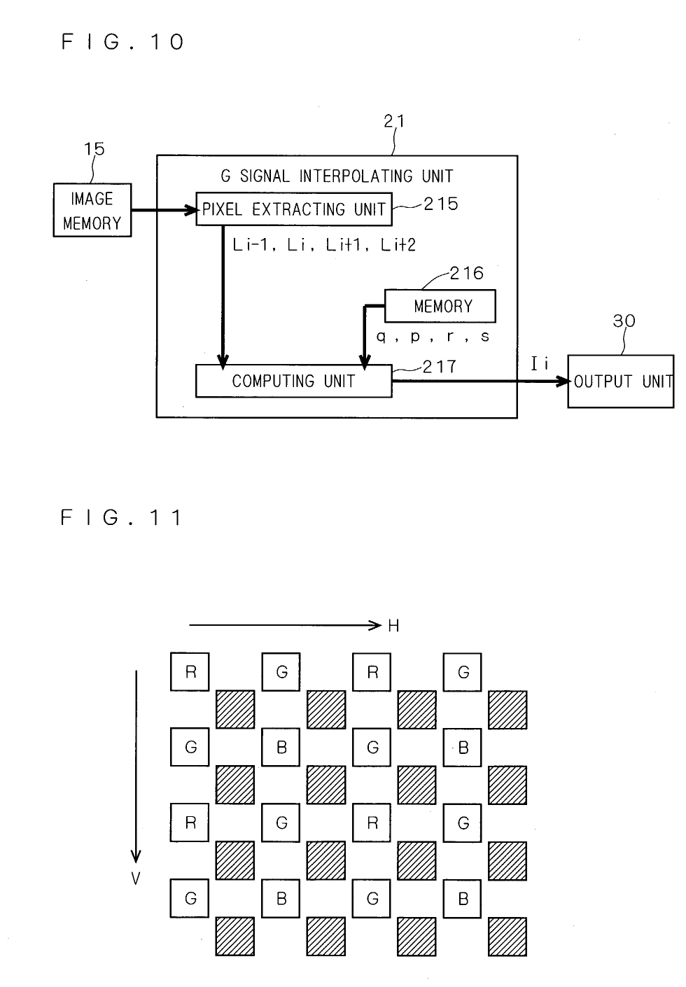

FIG. 9 is a diagram showing pixel apertures 41a, 42a, 43a and 44a of four pixels. The pixels neighboring in the X-direction are overlapped with each other by the quarter of the pixel aperture. With respect to the pixel aperture 42a having the pixel aperture center position Xci, a relational expression as shown by Equation 4 is satisfied. When the arithmetic operation as described above is performed on each of the lined four pixels from the pixel aperture 41a having the pixel aperture center position Xci−1 to the pixel aperture 41d having the pixel aperture center position Xci+2, four simultaneous equations regarding the coefficients a, b, c and d specifying the distribution of illumination are obtained.

By solving the four simultaneous equations, each of the coefficients a, b, c and d specifying the distribution of illumination is determined. When an output signal from the pixel in the pixel aperture center position Xci−1 is Li−1, an output signal from the pixel in the pixel aperture center position Xci+1 is Li+1, and an output signal from the pixel in the pixel aperture center position Xci+2 is Li+2, the coefficients a, b, c and d are defined by linear expressions of Li−1, Li, Li+1 and Li+2, respectively.

By applying the concept of processing as described above to the function setting unit 212 in the G signal interpolating unit 21, on the basis of the G signals Li−1, Li, Li+1 and Li+2 obtained from the four pixels 41, 42, 43 and 44 extracted by the pixel extracting unit 211, the coefficients a, b, c and d specifying the distribution of illumination are obtained, and an illumination distribution function f(X) is computed.

Subsequently, as shown by a hatched area in FIG. 9, the computing unit 213 computes a signal value of a pixel 45 to be interpolated (that is, an interpolated green pixel) in the center position of the pixel apertures 41a, 42a, 43a and 44a corresponding to the extracted four pixels. Concretely, when the G signal of the pixel 45 to be interpolated is Ii, by setting the integral interval to an interval from Xci to Xei so that the aperture ratio of the pixel to be interpolated becomes 100%, the G signal Ii can be obtained (see FIG. 8). Specifically, the G signal value Ii of the pixel 45 to be interpolated is computed by the following equation:

$$Ii = 4 k {\int }_{Xci}^{Xei} g ( X ) f ( X ) ⅆ X / {( Xei - Xsi )}^{2} \qquad Equation 5$$

where, in Equation 5, k is known from the characteristic of the CCD image pickup device 13, and each of Xei, Xci and Xsi is preliminarily obtained from the relation between the characteristic of the optical low-pass filter 12 and the pixel arrangement of the CCD image pickup device 13. The function g(X) defining the pixel aperture can be also preset. Consequently, the G signal value Ii of the pixel 45 to be interpolated is defined by the linear equations of a, b, c and d in Equation 5. By substituting the coefficients a, b, c and d specifying the distribution of illumination obtained by the function setting unit 212 for Equation 5, the G signal value Ii of the pixel 45 to be interpolated is obtained. As a result, the G signal value Ii of the pixel 45 to be interpolated corresponding to the dropout pixel is outputted from the computing unit 213.

The G signal interpolating unit 21 repeatedly executes the interpolating operation on the dropout portion of the G signals, so that a G signal interpolated image in which the dropout pixels are interpolated is outputted.

FIG. 10 is a diagram showing another example of the detailed configuration of the G signal interpolating unit 21, which is different from the configuration of FIG. 7. The G signal interpolating unit 21 includes a pixel extracting unit 215, a memory 216 and a computing unit 217. The pixel extracting unit 215 has a function similar to that of the pixel extracting unit 211 in FIG. 7.

In Equation 5, the G signal value Ii of the pixel 45 to be interpolated is defined by the linear equations of the coefficients a, b, c and d. The coefficients a, b, c and d are defined by the linear equations of the G signals Li−1, Li, Li+1 and Li+2 detected by the four pixels 41, 42, 43 and 44 which are lined in the oblique direction, respectively. Therefore, Equation 5 may modified as follows:

Iᵢ=pLᵢ₋₁+qLᵢ+rLᵢ₊₁+sLᵢ₊₂ Equation 6

where, coefficients p, q, r and s are defined by a polynomial of total 12 position coordinates of Xci−1, Xci, Xci+1, Xci+2, Xsi−1, Xei−1 and the like in the oblique direction (X-direction). In the CCD image pickup device 13, pixels are arranged at equal intervals, and the positional relation is the same in any of four pixels which are lined obliquely on the same device. Consequently, the coefficients p, q, r and s in Equation 6 are constants determined by the CCD image pickup device 13 and the optical low-pass filter 12.

In the G signal interpolating signal 21 in FIG. 10, the coefficients p, q, r and s in Equation 6 are preliminarily computed and stored in the memory 216.

The computing unit 217 receives the G signals Li−1, Li, Li+1 and Li+2 of the four green light sensing pixels 41, 42, 43 and 44 (see FIG. 4) which are lined in the oblique direction from the pixel extracting unit 215 and receives the coefficients p, q, r and s from the memory 216. By performing a filtering operation of four pixels on the basis of Equation 6, the G signal value Ii of the pixel 45 to be interpolated is obtained. The G signal interpolating unit 21 repeatedly executes the interpolating operation (filtering operation) on the basis of the G signals of four pixels which are lined in the oblique direction, thereby outputting a G signal interpolated image in which the dropout pixels are outputted.

A case of performing an interpolating operation different from the above in the G signal interpolating unit 21 in FIG. 10 will now be described. Since a signal value obtained from each green light sensing pixel is a signal obtained by integrating the illumination distribution function f(X) and averaging the integrated value. Consequently, the wider the integral interval (that is, the aperture area) becomes, the lower the sharpness of the G signal becomes. For example, the integral interval in Equation 5 is from Xci to Xei. When the integral interval becomes narrower, the aperture ratio of each pixel becomes smaller than 100%, and the sharpness of the G signal increases. When the coordinate Xi in the center position of the pixel to be interpolated is substituted for the illumination distribution function f(X), the image surface illumination in the center position is derived. Thus, the sharpness of the G signal can be set to the maximum.

In the case of obtaining a sharp G signal interpolated image, the G signal value Ii of the pixel to be interpolated can be computed by the following equation:

Ii=kf(Xi) Equation 7

where Xi denotes a coordinate value indicative of the center position of the pixel 45 to be interpolated in FIG. 9. Since the G signal value Ii in Equation 7 is also defined by linear expressions of the coefficients a, b, c and d, in a manner similar to the case of Equation 6, by prestoring the coefficients regarding the G signals Li−1, Li, Li+1 and Li+2 into the memory 216, the interpolating operation on a G signal can be efficiently executed. In this case, a sharp G signal interpolated image is generated by the G signal interpolating unit 21.

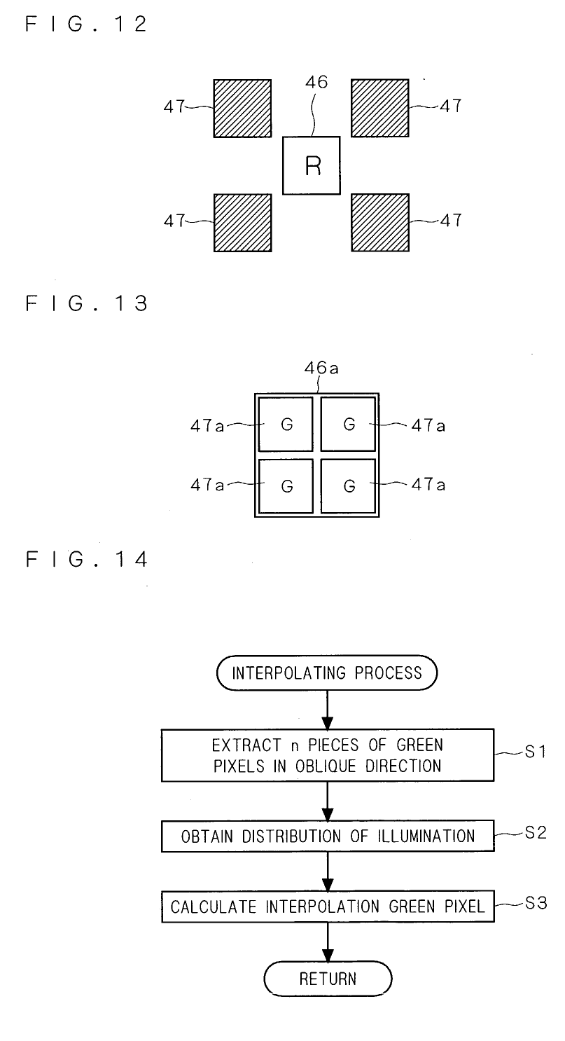

As a result of performing the interpolating operation on all of combinations of the four pixels lined obliquely by the G signal interpolating unit 21 having the configuration of FIG. 7 or 10, an interpolated pixel having the hatched position as a center as shown in FIG. 11 is generated and a G signal interpolated image in which lattice points are aligned in each of the horizontal and vertical directions H and V is generated. The center position of the interpolated pixel in the G signal interpolated image is deviated from the center position of the pixels (pixels labeled with R, G and B in FIG. 11) in the original CCD image pickup device 13 by a half pixel and is in a state where the aperture ratio of the interpolated pixel is corrected by the interpolating operation (specifically, almost to 100%).

Consequently, as shown in FIG. 12, when an attention is paid to one red light sensing pixel 46 included in a red image signal, the red light sensing pixel 46 is in a state where its aperture ratio is virtually increased to 200% by the effect of the optical low-pass filter 12. In contrast, each of interpolated pixels 47 in the G signal interpolated image in the periphery has the aperture ratio of 100%.

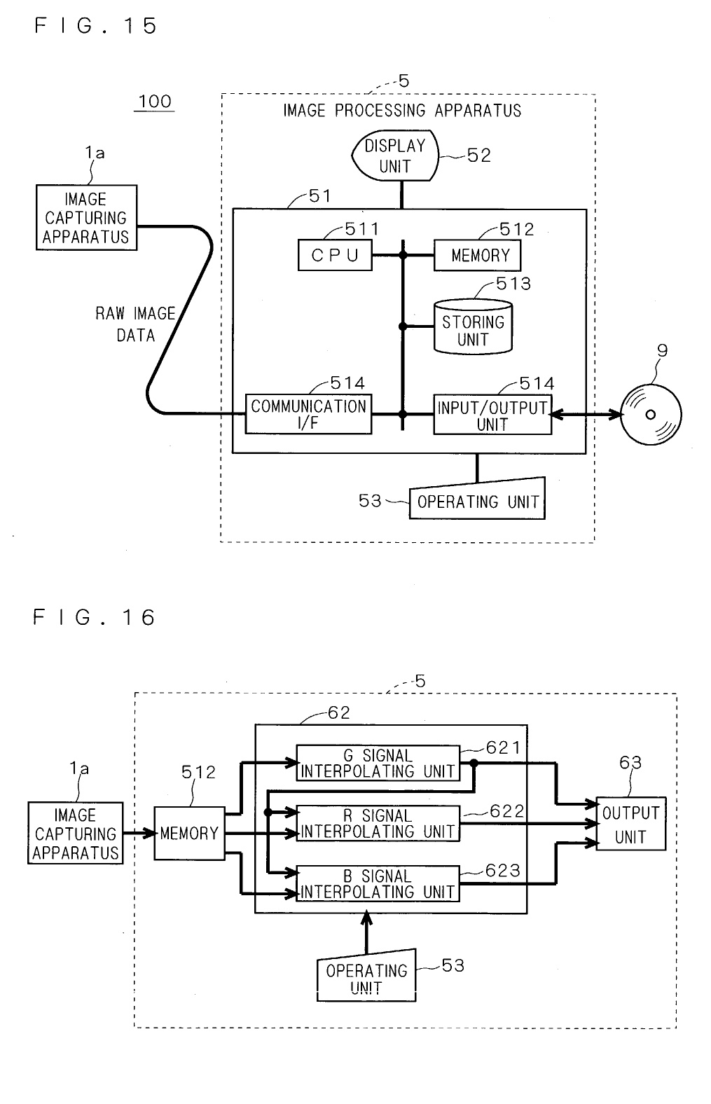

Therefore, when the positional relation of each of pixels shown in FIG. 12 is expressed as a pixel aperture, a state as shown in FIG. 13 is obtained and pixel apertures 47a of the interpolated pixels 47 are included in a pixel aperture 46a of the red light sensing pixel 46. Therefore, higher alignment between the interpolated pixel 47 and the red light sensing pixel 46 is realized.

In the R signal interpolating unit 22, a color difference component Cr is obtained by calculating the difference between the R and G signals. In this case, by subtracting the average value of the G signal values Ii obtained with respect to the four interpolated pixels 47 from the R signal, the color difference component Cr can be obtained from the signal in the same position in the image plane. Thus, the color difference component Cr can be calculated with high precision.

In the R signal interpolating unit 22, a high frequency component of a green image signal of high sampling frequencies is added to a red image signal of lower sampling frequencies. Consequently, it is suitable in the case where the color difference component Cr is obtained and the R signal interpolated image is generated.

Further, the above is applied not only the R signal but also similarly to the B signal. By performing the G signal interpolating process described in the embodiment, also at the time of performing the interpolating process on the R and B signals in the R signal interpolating unit 22 and B signal interpolating unit 23, respectively, the high-precision interpolating process can be carried out.

As the configuration of the G signal interpolating unit 21, two kinds of configurations of FIGS. 7 and 10 have been described. Any of the configurations may be employed. As in the G signal interpolating unit 21 shown in FIG. 10, by preliminarily calculating the coefficients p, q, r and s in Equation 6 and storing them in the memory 216, the G signal interpolating operation can be performed more efficiently as compared with the configuration of FIG. 7.

As described above, the image capturing apparatus 1 in the embodiment is constructed so that the image process is performed like in the procedure shown in FIG. 14 and the process of interpolating the green image signal outputted from the CCD image pickup device 13 having the Bayer pattern is performed. Specifically, in the process of interpolating the green image signal, total n pieces (n=4 in the above description) of green light receiving pixels which include two nearest neighbor green light sensing pixels in an oblique direction and exist in the same direction are extracted (step S1), and the distribution of illumination of a green image received by the four green light sensing pixels is obtained (step S2). The distribution of illumination is approximated by the (n−1)th order function (cubic function in the above description) and, on the basis of the cubic function, a signal value of an interpolation green pixel (pixel to be interpolated) positioned in the center of the four green light sensing pixels is derived (step S3). By the steps, the green signal interpolating process is executed.

In the interpolating method employed for the image capturing apparatus 1, an interpolating process is performed in pixel lines lined in an oblique direction and close to each other. The distance of original pixels for obtaining the signal value of a pixel to be interpolated is 1/√2 of the pixel pitch P2. Therefore, even in the case of capturing an image of a high-frequency stripe pattern in which the maximum and the minimum are almost equal to a pixel pitch or the like, the stripe pattern can be reproduced accurately. Excellent reproducibility of the high-frequency pattern is achieved and an interpolation error can be suppressed.

In the interpolating method of the embodiment, a reference area which is referred to in order to obtain the signal value of the pixel to be interpolated and the number of reference pixels are smaller as compared with the conventional method. Thus, the computation amount in the G signal interpolating unit 21 is reduced, and the G signal interpolated image can be obtained efficiently. Simultaneously, the circuit scale can be reduced. Thus, reduction in size and cost of the image capturing apparatus 1 can be achieved.

Further, in the above-described interpolating method, a cubic function specifying the illumination distribution is set so that the value obtained by integrating the illumination distribution in the pixel aperture with respect to the four green light sensing pixels becomes a signal value of a green light sensing pixel. Consequently, the illumination distribution adapted to actual photoelectric conversion can be set, and the G signal interpolating process can be performed with high precision.

At the time of setting the illumination distribution function, the pixel aperture is set so as to be adapted to an area virtually enlarged by the optical low-pass filter 12. Therefore, the distribution of illumination received by each pixel in the CCD image pickup device 13 can be reproduced accurately.

2. Second Embodiment

A second embodiment will now be described. The second embodiment relates to an image processing system in which an image capturing apparatus such as a digital camera and an image processing apparatus such as a computer are electrically connected to each other, and a process of interpolating a green signal is performed on the image processing apparatus side.

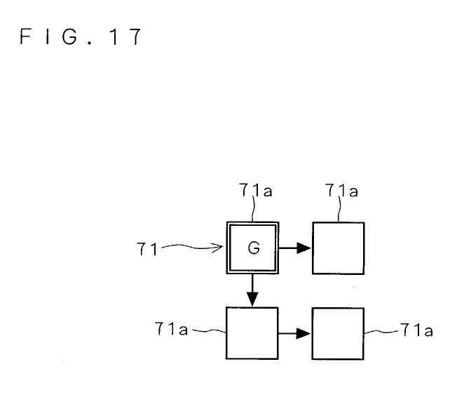

FIG. 15 is a diagram showing a schematic configuration of an image processing system 100. An image capturing apparatus 1 a has therein CCD image pickup devices of a Bayer pattern. The image capturing apparatus 1 a outputs raw image data captured by the CCD image pickup devices to an image processing apparatus 5 taking the form of a general computer or the like.

The image processing apparatus 5 includes a data processing unit 51 for performing various data processes including an image signal interpolating process, a display unit 52 for displaying an image by the control of the data processing unit 51, and an operating unit 53 used by the user to perform an operation input. Further, the data processing unit 51 includes: a CPU 511 for executing various data processes such as an interpolating operation by executing a predetermined program; a memory 512 for storing temporal data, image signals and the like at the time of a data process by the CPU 511; a storing unit 513 such as a magnetic disk drive for storing a program to be executed by the CPU 511, an interpolated image signal and the like; a communication interface (I/F) 514 for performing data communications with the image capturing apparatus 1a; and an input/output unit 515 for recording data to a recording medium 9 such as a CD-R or reading a program or the like recorded on the recording medium 9 and installing it to the storing unit 513.

The CPU 511 reads an image interpolating program stored in the storing unit 513 and executing the program, thereby realizing the function of performing an interpolating process on raw image data inputted from the image capturing apparatus 1a in the image processing apparatus 5. Alternately, the CPU 511 may read the image interpolating program directly from the recording medium 9 and execute the program. The process in the image processing apparatus 5 will be described later.

FIG. 16 is a diagram showing the function realized by the image processing apparatus 5. The image processing apparatus 5 receives raw image data from the image capturing apparatus 1a and temporarily stores it to the memory 512. In the data processing unit 51, by the action of the CPU 511, the functions of an image interpolating unit 62 and an output unit 63 are realized. The output unit 63 is a function unit for outputting and displaying an interpolated image signal obtained from the image interpolating unit 62 onto the display unit 52 or outputting and recording an interpolated image signal to the storing unit 513, recording medium 9 or the like.

The image interpolating unit 62 functions as a G signal interpolating unit 621, an R signal interpolating unit 622 and a B signal interpolating unit 623.

The G signal interpolating unit 621 extracts G signals distributed in the checker pattern from the memory 512, executes an interpolating process on a dropout pixel, and outputs a G signal interpolated image. The R signal interpolating unit 622 extracts a red signal (R signal) from the memory 512, receives a G signal interpolated image from the G signal interpolating unit 621 and, on the basis of the signal and the image, generates and outputs an R signal interpolated image. Similarly, the B signal interpolating unit 623 extracts blue signals (B signals) from the memory 512, receives a G signal interpolated image from the G signal interpolating unit 621 and, on the basis of the signal and the image, generates and outputs a B signal interpolated image.

Each of the G signal interpolating unit 621, R signal interpolating unit 622 and B signal interpolating unit 623 has a configuration similar to that described in the first embodiment and executes a similar process. Specifically, the G signal interpolating unit 621 has a configuration similar to that of the G signal interpolating unit 21 shown in FIG. 7 or 10 and executes a similar process.

Consequently, the image processing apparatus 5 displays an effect similar to that of the first embodiment.

When only one kind of the image capturing apparatus 1a which can be connected to the image processing apparatus 5 exists, it is sufficient to preset an integral interval applied for the G signal interpolating unit 621, a coefficient, and the like on the basis of the characteristics such as the CCD image pickup device of the image capturing apparatus 1a.

On the other hand, in the case where the image capturing apparatus 1a of a kind in which pixel pitches of the CCD image pickup devices are different from each other can be connected to the image processing apparatus 5, the G signal interpolating unit 621 prestores a plurality of kinds of integral intervals, coefficients, and the like in accordance with the kind of an image capturing apparatus. On the basis of the kind of an image capturing apparatus inputted from the operating unit 53 by the user, the G signal interpolating unit 621 performs a G signal interpolating process by applying an integral interval, a coefficient and the like adapted to the image capturing apparatus 1a from the plurality of kinds of integral intervals, coefficients and the like.

With such a configuration, also in the image processing apparatus 5 to which raw image data can be inputted from a plurality of kinds of image capturing apparatuses, an interpolating process adapted to the image capturing apparatus 1a connected to the image processing apparatus 5 can be executed.

The present invention is not limited to the case of designating the kind of an image capturing apparatus. The user may input various parameters directly in consideration of an optical low-pass filter and CCD image pickup devices provided for the image capturing apparatus.

3. Modification

Although the embodiments of the present invention have been described above, the present invention is not limited to the above-described embodiments.

For example, in the embodiments, the case of performing the interpolating process while the aperture ratio of a pixel is set to almost 100% and the image decomposition width P1 by the optical low-pass filter 12 is set to be equal to the pixel pitch P2 has been described. The present invention can be also applied to the other cases.

FIG. 17 is a diagram illustrating the case where the aperture ratio of a pixel is less than 100%. In the case where the aperture ratio of a pixel 71 is less than 100% as shown in the diagram, by the action of the optical low-pass filter 12, four aperture regions 71a are virtually formed. In this case as well, a G signal value obtained from the pixel 71 is determined by a sum of values derived by integrating the illumination distribution function f(X) with respect to the four aperture regions 71a. Therefore, in this case as well, by making setting so that the integral interval is determined on the basis of the coordinates of the four aperture regions 71a in Equation 3, each of coefficients of the illumination distribution function f(X) can be determined by a computing method similar to the above.

Also in the case where the number of separating rays by the optical low-pass filter 12 is larger than four, by similarly computing an integral value with respect to a plurality of aperture regions and obtaining the sum, each of the coefficients of the illumination distribution function f(X) can be determined.

Therefore, irrespective of the pixel aperture of the CCD image pickup device 13 and the separation width and the number of separating the rays of the optical low-pass filter 12, the present invention can be applied.

In the above-described embodiments, the case of extracting four pixels which are lined in an oblique direction from a green image signal and setting an illumination distribution function by a cubic function has been described. The number of pixels to be extracted for the interpolating operation is not limited to four but may be five or more. When five or more pixels are used, the illumination distribution function f(X) can be obtained with higher precision. In the case of using n pieces of pixels (where n is an integer of four or larger), to determine the illumination distribution function f(X) by the above-described arithmetic operation, it is preferable that the illumination distribution function f(X) be set to the (n−1)th order function.

Also in the case of setting the illumination distribution function f(X) by using n pixels, the n pixels do not have to be lined in an oblique direction. To obtain the signal value of a pixel to be interpolated with high precision, the distance between the pixel to be interpolated and original pixels is preferably short. It is therefore desirable to set so that the n pieces of pixels include two nearest neighbor green light sensing pixels in the oblique direction and obtain the pixel to be interpolated in the intermediate position of the two green light sensing pixels by the interpolating operation.

While the invention has been shown and described in detail, the foregoing description is in all aspects illustrative and not restrictive. It is therefore understood that numerous modifications and variations can be devised without departing from the scope of the invention.

What is claimed is:

1. An image processing method of performing a process of interpolating a green signal in an image signal outputted from an image pickup device having a Bayer pattern, comprising the steps of:
extracting total n pieces (where n is an integer of four or larger) of green light sensing pixels which include two nearest neighbor green light sensing pixels in an oblique direction and exist in the same direction as said two green light sensing pixels from the image signal;
obtaining an illumination distribution of a green image received by the n green light sensing pixels; and
deriving a signal value of an interpolation green pixel positioned in the oblique direction from said illumination distribution.

2. The method according to claim 1, wherein
said interpolation green pixel is in a midpoint position between said two green light sensing pixels.

3. The method according to claim 1, wherein
said illumination distribution is set as an (n−1)th order function so that a value obtained by integrating said illumination distribution at a pixel aperture with respect to each of said n green light sensing pixels becomes a signal value of each green light sensing pixel.

4. The method according to claim 3, wherein
said pixel aperture is a region virtually enlarged by an optical low-pass filter.

5. An image processing method of performing a process of interpolating a specific color element on an image signal outputted from an image pickup device in a state where a plurality of color elements constructing an image are distributed in a predetermined pattern, comprising the steps of:
extracting a plurality of pixels of said specific color element existing in an oblique direction from the image signal;
obtaining an illumination distribution of an image received by said plurality of pixels; and
obtaining a signal value of a pixel to be interpolated from said illumination distribution.

6. The method according to claim 5, wherein
said pattern of said plurality of color elements is a Bayer pattern.

7. The method according to claim 6, wherein
said plurality of color elements include signals regarding color components of red, green and blue.

8. The method according to claim 7, wherein
said specific color element is a signal of green.

9. The method according to claim 5, wherein
in said extracting step, the number of pixels to be extracted is n (where n is an integer of four or larger).

10. The method according to claim 9, wherein
said plurality of pixels include two nearest neighbor pixels.

11. The method according to claim 10, wherein
said n pixels are pixels which are continuous in an oblique direction.

12. The method according to claim 9, wherein
said illumination distribution is obtained by being set as the (n−1)th order function.

13. An image processing apparatus for performing a process of interpolating a green signal in an image signal outputted from an image pickup device having a Bayer pattern, comprising:
a pixel extracting unit for extracting total n pieces (where n is an integer of four or larger) of green light sensing pixels which include two nearest neighbor green light sensing pixels in an oblique direction and exist in the same direction as said two green light sensing pixels from the image signal;
an illumination distribution setting unit for obtaining an illumination distribution of a green image received by the n green light sensing pixels; and
a computing unit for deriving a signal value of an interpolation green pixel positioned in the oblique direction from said illumination distribution.

14. The apparatus according to claim 13, wherein
said interpolation green pixel is in a midpoint position between said two green light sensing pixels.

15. The apparatus according to claim 13, wherein
said illumination distribution setting unit sets said illumination distribution as the (n−1)th order function so that a value obtained by integrating said illumination distribution at a pixel aperture with respect to each of said n green light sensing pixels becomes a signal value of each green light sensing pixel.

16. The apparatus according to claim 15, wherein
said pixel aperture is a region virtually enlarged by an optical low-pass filter.
